(19) United States
(12) Patent Application Publication
(10) Pub. No.: US 2013/0068886 A1
(43) Pub. Date: Mar. 21, 2013

(54) PLATFORM FOR THE LANDING OF AN AIRCRAFT ON AN ACCESS FACILITY

(71) Applicant: Giovanni Besenzoni, Sarnico (BG) (IT)

(72) Inventor: Giovanni Besenzoni, Sarnico (BG) (IT)

(73) Assignee: B. FINANCIAL S.R.L., Sarnico (BG) (IT) (IT)

(21) Appl. No.: 13/636,629

(22) PCT Filed: Mar. 18, 2011
(86) PCT No.: PCT/IT11/00077

§ 371 Date: Nov. 28, 2012

(30) Foreign Application Priority Data
Mar. 22, 2010 (IT) VI2010A000080

(51) Int. Cl. B64F 1/00

(52) U.S. Cl. 244/110 E

(57) ABSTRACT

A platform (1) for the landing of an aircraft on an access facility, such as boat (B), comprising a support structure (2), suitable to firmly insist on a reference surface (P) of said access facility (B), and a landing footboard (3), connected above with said support structure (2) and suitable to receive the aircraft. The platform (1) includes translation means (4), interposed between the support structure (2) and the landing footboard (3), operatively connected with the landing footboard (3) in order to move it from/to a rest position, in which said landing footboard (3) totally re-enters with respect to the access facility (B) along a vertical axis (Z) orthogonal to the support plane of support (of floating in general) (W), remaining arranged under the open sky in order to define a support and/or sun deck landing accessible to the user, to/from one operating position in which the landing footboard (3) completely protrudes from the access facility (B) along the vertical axis (Z), becoming available for the landing of the aircraft.

The present invention refers to a platform for the landing of an aircraft on an access facility, preferably a boat.

In particular, when installed on boats, the platform of the invention is of the retractable type when not necessary for use, entirely re-entering into the overall dimensions of the hull of the boat, even along the vertical reference axis, orthogonal to the floating plane of the boat, while to remaining in view and usable by the owner and guests on board.

As known, the most modern and sophisticated sports crafts which reach even relevant lengths, in the order of tens of meters, are equipped with a platform for the landing of an aircraft at any circumstance, for example, when it is necessary to transport a person on board or it is desired to welcome guests on board when the boat is at open sea.

The platform mounted on board of a boat presents well defined and specific structural and functional features, suitable to comply with laws in force, for example, about security matters for the pilot during aircraft landing approaches: in particular, these laws relate to the sizes and visibility of the classic symbol “H”, printed on the upper part, and circle which surrounds it.

Currently, the landing platforms are typically mounted at the deck of the boat, placed in the middle at the top, better known in nautical circles with the term “fly”, which houses the command post.

The construction design of the platforms provides that they are firmly fixed in such a position, constantly occupying the space intended for them on the boat, while remaining always visible from the outside in the operating position useful to allow the correct and safe landing of the aircraft, but resulting substantially unusable when they have not to be used, exactly given their location on the fly devoid of any perimetrical protection.

The area of the deck of the boat in which platforms are today installed thus results largely unused and unusable when these are not used, while limiting, even if minimally, freedom of movement of the persons on board and preventing to intend at least part of the space occupied by them to other uses or applications in the normal operating position.

Moreover, just because of such a situation, the known landing platforms protrude vertically, representing in non-use position a body with high overall dimensions subject to accidental impacts by other moving structures or people, with the obvious disadvantages and inconveniences that this entails.

The present invention aims to overcome the drawbacks of the prior art set out above.

In particular, primary purpose of the invention is to provide a platform for the landing of an aircraft, in this case a helicopter, on an access facility presenting on the latter overall dimensions smaller than that of platforms of known type when at rest or not use position.

It is a further purpose of the present invention to devise a platform for the landing of an aircraft on an access facility which is exploitable for other uses in a safe and practical manner when not necessary to be used.

It is another purpose of the invention to make available a platform for the landing of an aircraft on an access facility, for example a boat, which reduces the risks of accidental impacts suffered by the platform when in rest position, harmful both for itself and for the facilities or people with which it eventually comes into contact.

It a last but not least purpose of the invention to indicate a platform for the landing of an aircraft on an access facility which can be mounted in any area of the facility itself notoriously narrow for such a component.

Said purposes are achieved through such a platform for the landing of an aircraft on an access facility as the attached claim 1, as hereinafter referred for the sake of brevity.

Other constructive features of detail of the platform of the invention are set forth in the corresponding dependent claims.

Advantageously, the platform of the invention comes re-enters almost entirely, according to the canonical three axes X, Y and Z, inside the overall dimensions of the access facility, for example the hull of the boat, when at rest position, significantly although within certain limits reducing its own size and still positioning the landing platform in view.

Still advantageously, the platform object of the present invention, when at rest or non-use position, avoids much more than the platforms of the known art the risk of accidental impacts against it by other structures and persons in motion (e.g. during maintenance operations when the boat is moored or during moments of rest or relax on the boat).

Equally advantageously, the platform of the invention, when at rest position, can be used by people in a completely safe and comfortable way as sun deck landing or support plane of any object.

In advantageous manner, furthermore, the platform for the landing of an aircraft on an access facility can be mounted in any area suitable for the purpose; in case of a boat, for example, the platform is preferably mounted at prow, aspect which causes an enlargement of the range of applicative solutions compared to the current state of the art.

The range of advantages listed above comes from the fact that, in the invention, the landing platform is operatively connected with translation means which move them between the rest position and operating position and vice versa so that, in the rest or non-use position, the landing platform re-enters with respect to the access facility, for example, the hull of the boat, along the vertical axis perpendicular to the plane of support which, in case of boats, is the floating plane.

The just cited advantages become even more relevant in the light of the fact that a platform like that one of the invention generally performs the function to which is properly designed not so frequently and only when necessary, providing a component that remains virtually unused for most of the time.

Said purposes and advantages will be better known from the description that follows, relating to a preferred embodiment of the platform object of the current invention, given as indicative and illustrative, but not be limited, way with reference to the attached drawing tables, where:

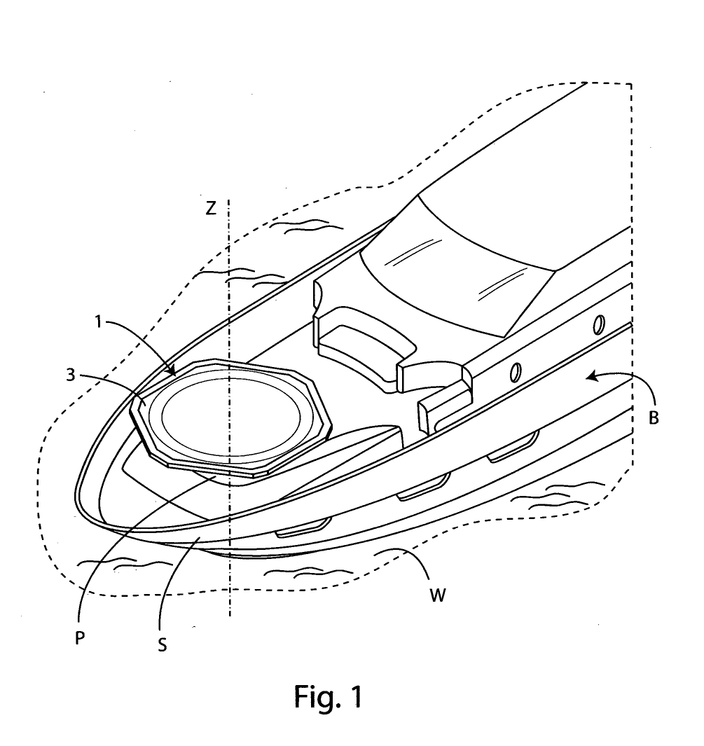

FIG. 1 is an assonometric view of the platform of the invention in applicative conditions and in the operating position;

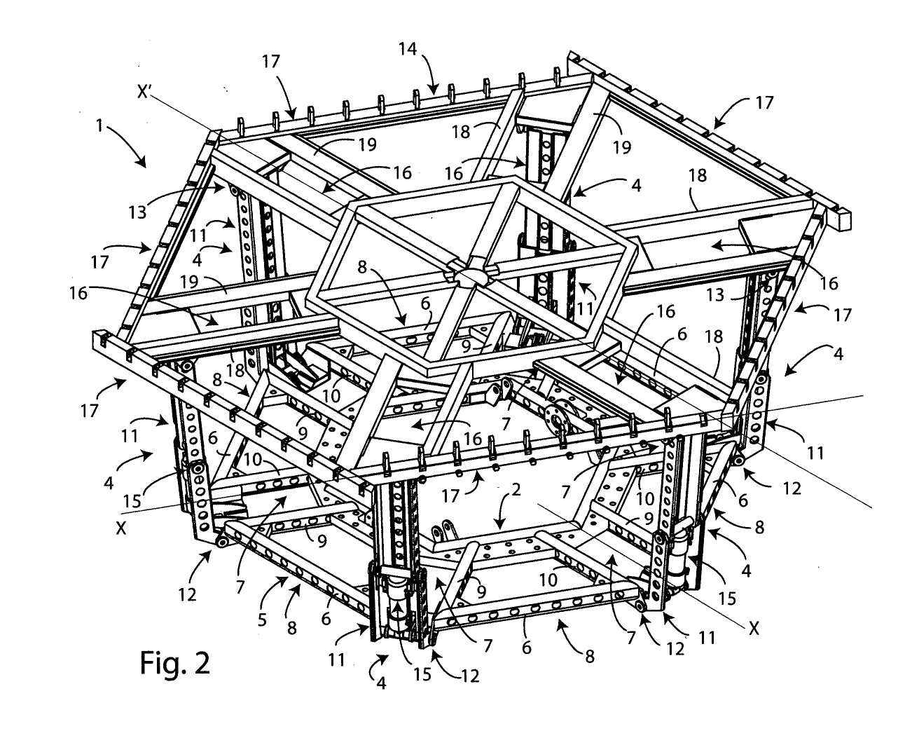

FIG. 2 is a simplified and partial assonometric view of the platform of FIG. 1 in operating position;

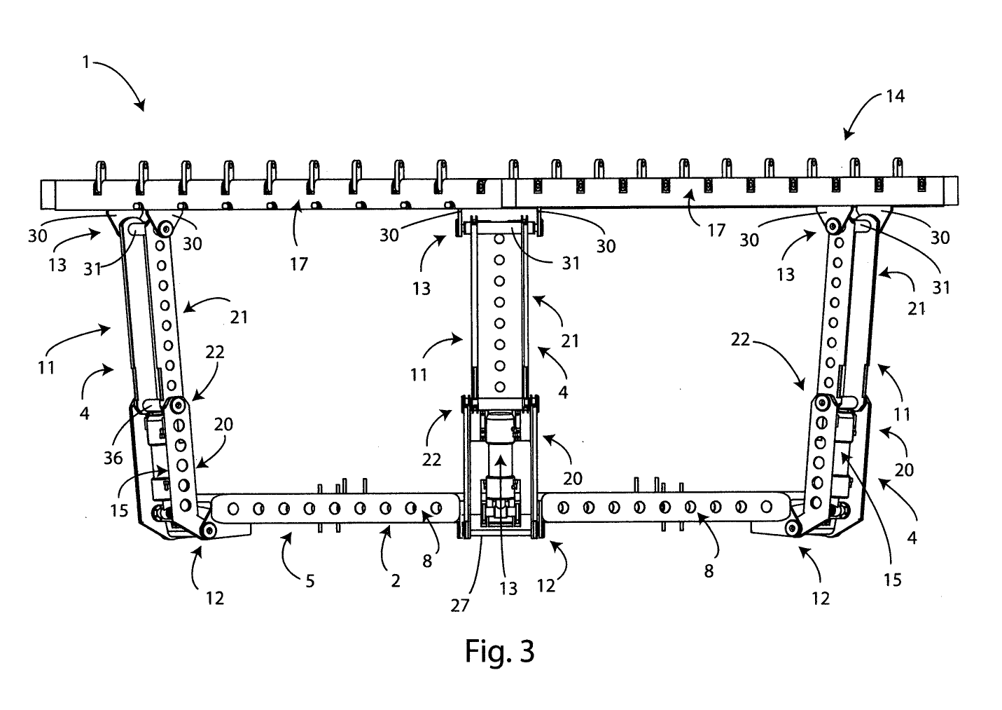

FIG. 3 is a side view of FIG. 2;

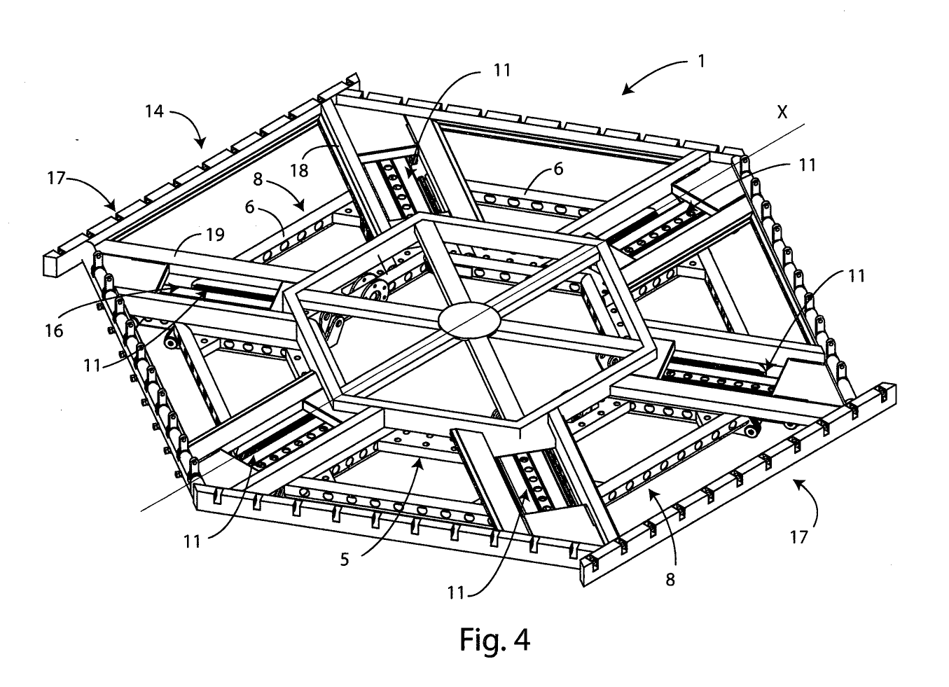

FIG. 4 is a simplified and partial assonometric view of the platform of FIG. 1 in the rest position;

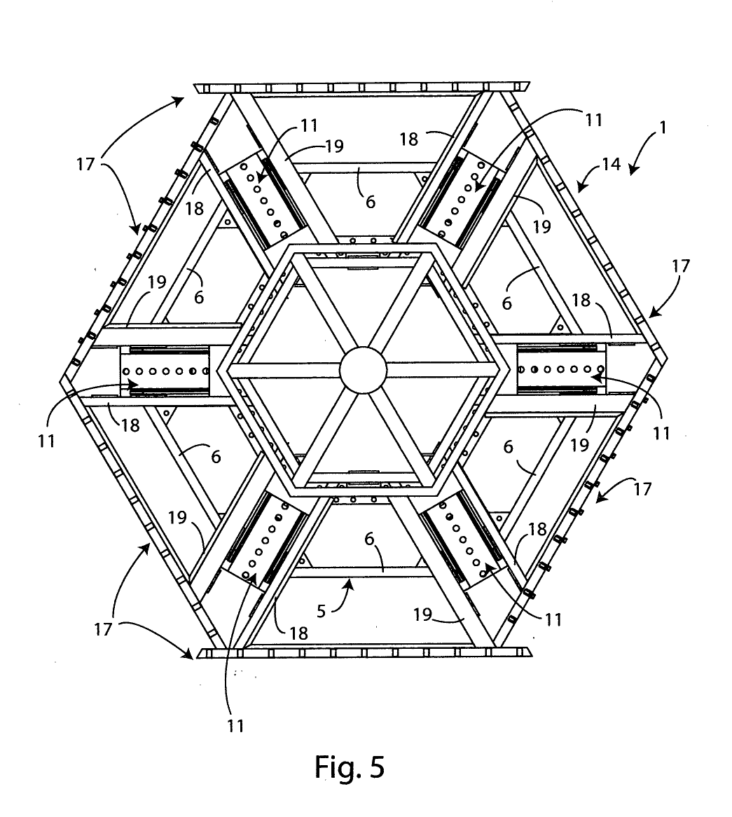

FIG. 5 is a plan view of FIG. 4;

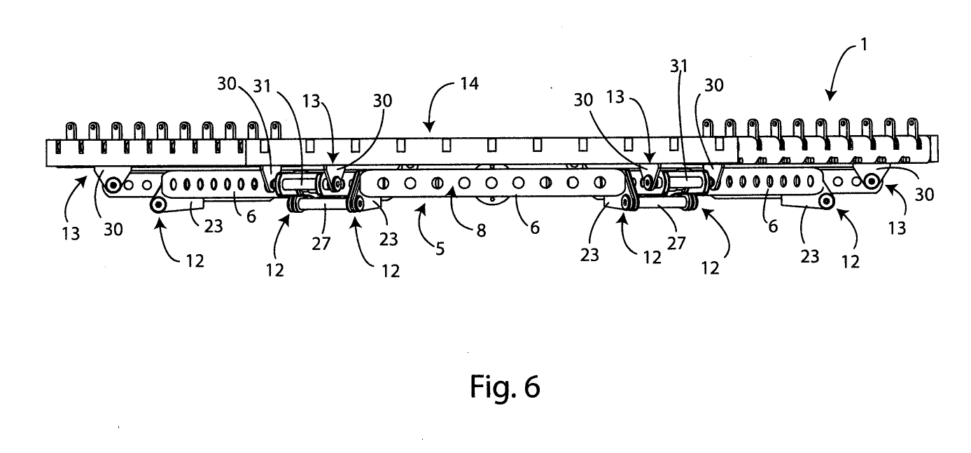

FIG. 6 is a side view of FIG. 4;

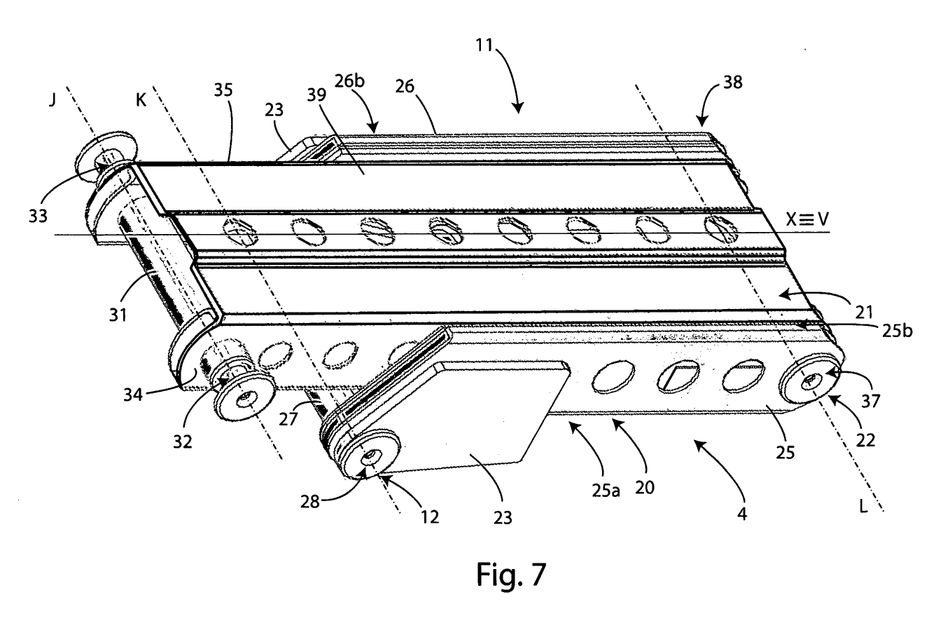

FIG. 7 is an enlarged assonometric view of an articulated arm of the platform of FIGS. 2 and 4 in the rest position of the latter;

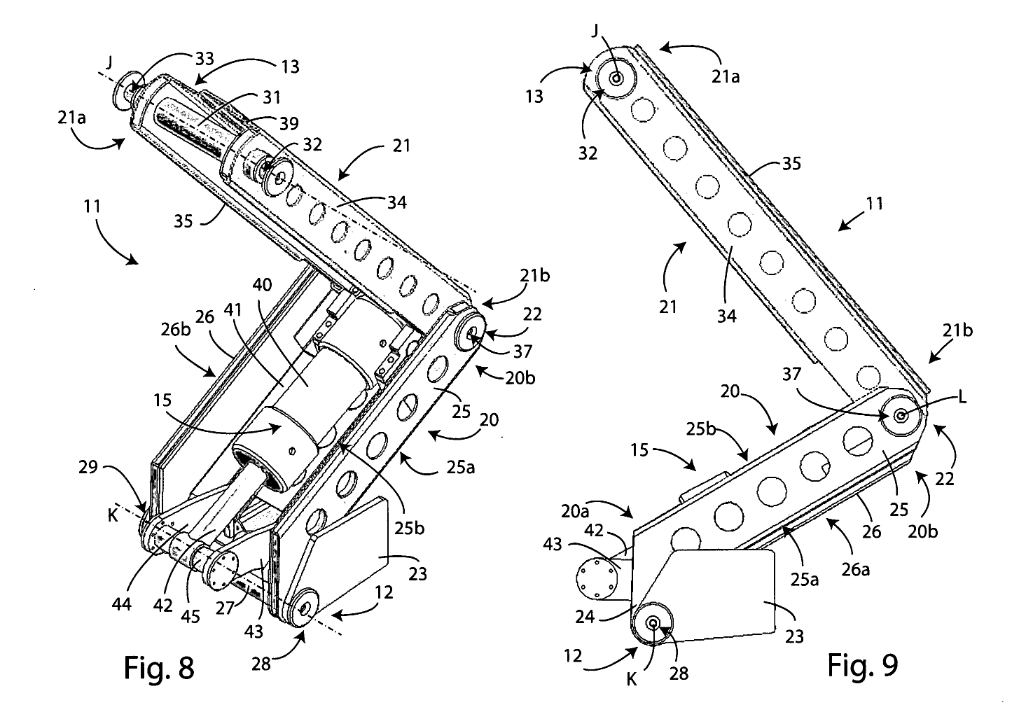

FIG. 8 is an assonometric view of the articulated arm of FIG. 7 during a phase of the transition of the platform of FIGS. 2 and 4 from the rest position to the operating position;

FIG. 9 is a side view of FIG. 8;

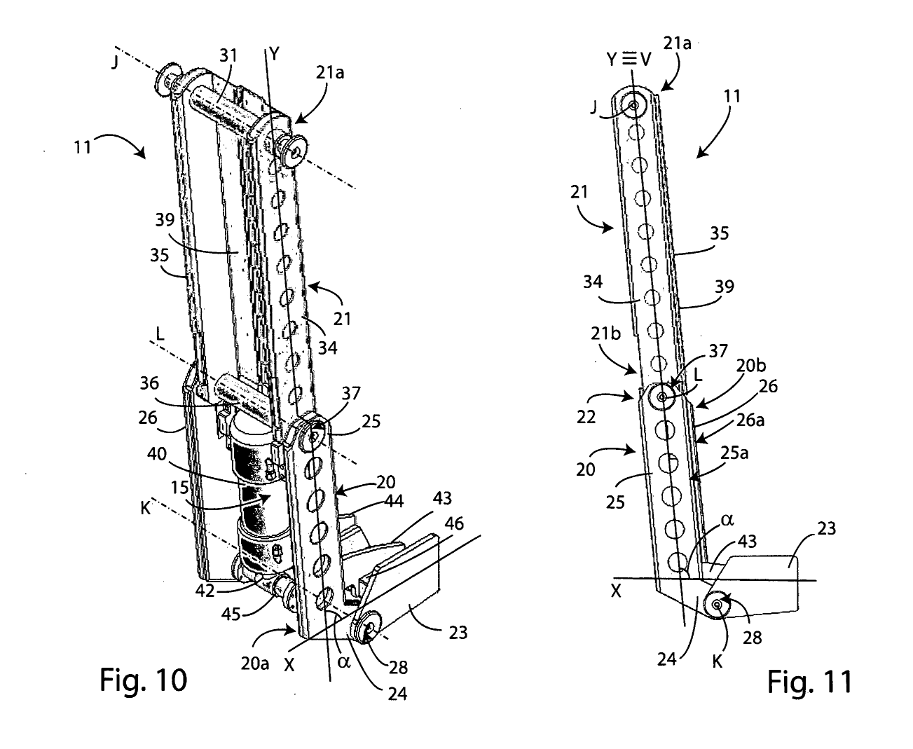

FIG. 10 is an assonometric view of the articulated arm of FIG. 7 in the operating position of the platform of FIGS. 2 and 4;

FIG. 11 is a side view of FIG. 10.

The platform of the present invention is illustrated in FIG. 1, where it is globally indicated with 1.

It is properly to be fitted for the landing of an aircraft, usually a helicopter, on an access facility, in the specific case consisting of a boat B, such as a yacht or super yacht always visible in FIG. 1.

As it can be seen, the platform 1 comprises:
a support structure, on the whole indicated with 2, which, in applicative conditions, firmly insists on a reference surface P, belonging, for the sake of example, to the prow zone of the boat B;
a landing footboard 3, connected above with the support structure 2 and suitable to receive the aircraft parked on the boat B.

According to the invention, the platform 1 includes translation means, as a whole numbered with 4, interposed between the support structure 2 and the landing footboard 3, operatively connected with the landing footboard 3 itself in order to move it to/from a rest position, in which the landing footboard 3 re-enters at least partly with respect to the boat B along a vertical axis Z orthogonal to the floating plane W, remaining arranged under the open sky in order to define a support and/or sun deck landing accessible to the user, to/from an operating position in which the landing footboard 3 completely protrudes from the boat B along the vertical axis Z, becoming available for aircraft landing and parking.

More specifically, in the aforesaid rest position, the landing footboard 3 re-enters completely, according to the vertical axis Z, into the overall dimensions defined by the hull S of the boat B so that the user can use the sun deck landing completely safely, standing or lying down.

Preferably but not necessarily, the support structure 2 comprises a composite pedestal, generically indicated with 5, having a star-shaped profile and connected with a reference plate, not represented for the sake of simplicity of exposition, which is directly fixed to the reference surface P of the boat.

FIG. 2 shows that, advantageously, the composite pedestal 5 presents a plurality of perimetrical seats 7 radially facing outwardly, uniformly distributed on the composite pedestal 5 itself and spaced apart each other by trapezoidal gores 8.

In this case, purely by way of illustration and example, the perimetrical seats 7 are six in number, distributed substantially in accordance with the vertices of a hexagon on the composite pedestal 5.

It is clear that other embodiments of the invention, not shown, may provide that the composite pedestal presents a number of perimetrical seats different than that one just indicated, depending on the choices made at constructive level.

Each of the trapezoidal gores 8 just cited (in the present example they are six in number as well) include two oblique bars 9, 10 laterally delimiting the perimetrical seats 7 and a longitudinal bar 6, connected with the oblique bars 9, 10 in order to form the major basis of every trapezoidal gore 8 and facing outside.

In particular, a first oblique bar 9 of each trapezoidal gore 8 cooperates to delimit a given perimetrical seat 7, while the second oblique bar 10 of such a trapezoidal gore 8 cooperates to delimit the adjacent perimetrical seat 7.

FIG. 4 highlights that, in the rest position of the landing footboard 3, the translation means 4 are substantially contained in the perimetrical seats 7 of the composite pedestal 5 assuming a configuration that defines a radial direction X.

In the operating position of the landing footboard 3 of FIGS. 2 and 3, instead, the translation means 4 protrude upwards in a substantially oblique direction Y which defines with the radial direction X an obtuse angle α, in this case slightly higher than the right angle, as it will be better explained below using the FIGS. 7-11.

According to the preferred embodiment of the invention described herein, the translation means 4 comprise:
a plurality of articulated arms, each of which overall indicated with 11 and coupled with:
   the composite pedestal 5 through first constraint means, as a whole numbered with 12 and arranged at the perimetrical seats 7, on one hand,
   through second constraint means, on the whole indicated with 13, with a star-shaped frame 14 which inferiorly supports the landing footboard 3, and in the rest position of the latter, is placed positioned parallelly and superiorly close to the composite pedestal 5 itself, on the other hand;
a plurality of linear actuators, each of which indicated with 15, cooperating with the respective articulated arms 11 in order to move the landing footboard 3 between the rest position and operating position and vice versa, and operatively connected with control means at user's disposal, not shown and constituted, for example, by a hydraulic switchboard provided with a processing and control unit.

Under the preferred construction design of the composite pedestal 5 of the present case, the articulated arms 11 and the corresponding linear actuators 15 are, always by indicative way, six in number.
It is understood that in other embodiments of the invention, not shown, the number of articulated arms and linear actuators could be different from that one just indicated, despite the fact that such a number remains compatible with the construction design chosen for the composite pedestal and, in particular, with the number of perimetrical seats therein defined.

The star-shaped frame 14 presents a plurality of closed profile peripheral compartments 16, uniformly distributed on it according to the vertices of a hexagon and along radial lines X′ parallel to the radial direction X, as well as spaced apart each other by trapezoidal sectors 17.

What has been said for the articulated arms and the linear actuators of the translation means is valid also for the trapezoidal sectors 17, which in the case at issue are six in number, equal to the number of trapezoidal gores 8: in further constructive solutions of the invention, the number of these trapezoidal sectors will vary with respect to that one here described in accordance with the number of trapezoidal gores or perimetrical seats of the composite pedestal.

Each of the trapezoidal sectors 17 is equipped with oblique section bars 18, 19 laterally delimiting the peripheral compartments 16.

More properly, a first oblique section bar 18 of each trapezoidal sector 17 cooperates to define a specific peripheral compartment 16, while the second oblique section bar 19 of each trapezoidal sector 17 cooperates to define the adjacent peripheral compartment 16.

On the basis of what just said, in the rest position of the landing footboard 3, the peripheral compartments 16 and the trapezoidal sectors 17 of the star-shaped frame 14 substantially face respectively the perimetrical seats 7 and the trapezoidal gores 8 of the composite pedestal 5, as it can be derived in FIG. 5.

In addition, in such a rest position, the composite pedestal 5 and the star-shaped frame 14 are placed one close to the other according to planes substantially horizontal, as it can be observed in FIG. 6.

FIGS. 6-10 illustrate that, in a preferred but not exclusive manner, each articulated arm 11 comprises:
a first protection plate 20 which contains one of the linear actuators 15 and is revolvingly connected with the composite pedestal 5 through the first constraint means 12;
a second protection plate 21 revolvingly connected with the star-shaped frame 14 through the second constraint means 13 and with the first protection plate 20 through third constraint means, referred to collectively with 22.

More in detail, the first constraint means 12 preferably comprise:
a pair of anchor brackets 23 facing and spaced apart each other, partially contained in each of the perimetrical seats 7 and fixed one inside each of the oblique section bars 9, 10 opposite each other of two of the trapezoidal gores 8 mutually adjacent of the composite pedestal 5;
a pair of strike fins 24 facing and spaced apart each other, projecting at a first end 20a of the first plate 20, from the bottom edge 25a, 26a of the side walls 25, 26 of the first plate 20 and placed between the anchor brackets 23 to which are partly facing;
a first shaft 27 which defines a first rotation axis K and is provided with end pins 28, 29 coupled with first through holes, not shown for the sake of simplicity of exposition, coaxial each other made in the anchor brackets 23 and in the strike fins 24 in order to make them mutually integral.

In this case, the strike fins 24 are monolithic with the respective side walls 25, 26 of the first plate 20, cooperating to define for the first plate 20 itself a substantially L-shaped (or mechanical square) profile in side view.

As far as the second constraint means 13 are concerned, they preferably but not necessarily include:
a pair of hooking brackets, 30, partially contained in each of the peripheral compartments 16 and fixed one inside each of the oblique section bars 18, 19 facing and opposite each other of each of the trapezoidal sectors 17 of the star-shaped frame 14;
a second shaft 31 defining a second rotation axis J, parallel to the first rotation axis K and equipped with end pins 32, 33 coupled with through openings, not visible, coaxial each other made in the hooking brackets 30 and in the side walls 34, 35 of the second plate 21, at a first end 21a thereof.

The third constraint means 22 comprise, in turn, a third shaft 36 defining a third rotation axis L, parallel to the first rotation axis K and the second rotation axis J.

The third shaft 36 is provided with end pins 37, 38 coupled with second holes, not indicated, coaxial each other made in the side walls 25, 26 of the first plate 20 and the side walls 34, 35 of the second plate 21, at a second end 20b of the first plate 20 and a second end 21b of the second plate 21.

It follows that in the rest position of the landing footboard 3, the second plate 21 is contained in the first plate 20 so that each of the linear actuators 15 is completely enclosed between the first plate 20 and the second plate 21, as it is well shown by FIG. 7.

Specifically, the bottom 39 of the second plate 21 is substantially coplanar to the upper edge 25b, 26b of the side walls 25, 26 of the first plate 20 in such a rest position of the landing footboard 3.

On the other hand, in the operating position of the landing footboard 3, the second plate 21 is aligned with the first plate 20 along the substantially oblique direction Y, as it is clearly highlighted by FIGS. 10 and 11: in this configuration, the bottom 39 of the second plate 21 is substantially coplanar with the lower edge 25a, 26a of the side walls 25, 26 of the first plate 20.

Preferably, each linear actuator 15 is of the hydraulic type and is provided with an outer liner 40, fixed to the bottom 41 of the first plate 20, and a power stem 42 connected through a pair of connecting arms 43, 44 and a rotation pin 45 with a support plate 46 contained in each of the perimetrical seats 7 and integral to the inner surface 23a of the anchor brackets 23.

In the rest position of the landing footboard 3, the power stem 42 protrudes axially up to end-of-stoke from the outer liner 40, so that the longitudinal axis V of the power stem 42 coincides with the radial direction X, as illustrated by FIG. 7.

In the operating position of the landing footboard 3, instead, the power stem 42 re-enters up to end-of-stroke into the outer liner 40, so that the longitudinal axis V of power stem 42 coincides with the substantially oblique direction Y, according to what shown by FIGS. 10 and 11.

Other embodiments of the invention, not shown in the drawings that follow, could exist in which the platform for landing an aircraft on a boat differs from that one just described and indicated with 1 for the different composition of the translation means.

For example, the translation means may include, beyond to a series of peripheral linear actuators of the type described above, an auxiliary reinforcement actuator, operatively connected with the control means, connected to the midpoint of the star-shaped frame which supports the landing platform and the centre point of the composite pedestal distinguishing the support structure.

The auxiliary actuator will then act synchronously with the other linear actuators along a central axis orthogonal to the reference planes of the composite basement and the star-shaped frame.

Operatively, the platform 1 is in the specific case mounted at prow P of the boat B, in such a way that the translation means 4 position the landing footboard 3 in the rest position illustrated in FIGS. 4-6. In this position, each of the articulated arms 11 of the translation means 4 assumes the configuration of FIG. 7, where the first plate 20 and the second plate 21 close as a sandwich the linear actuators 15, resulting arranged along the radial direction X, and the power 42 of each the linear actuator 15 protrudes axially up to end-of-stroke from the outer liner 40, orienting its own longitudinal axis V in accordance with the radial direction X.

Moreover, the landing footboard 3 re-enters with respect to the hull S of the boat B also according to the vertical axis Z so that the owner and/or people on board may use the footboard 3 as a support and/or sun deck landing to lie down and thus enjoy safely and relaxing moments of air and/or open sea.

When necessary, in order to allow the landing of any kind of aircraft, such as a helicopter, the master of the boat B, by activating the control means, moves the various actuators 15 and with them the articulated arms 11, bringing the latter, from the configuration of FIG. 7, to progressively position in a series of intermediate configurations, one of which shown in FIGS. 8 and 9, until the final configuration shown in FIGS. 10 and 11, corresponding to the operating position of the landing footboard 3.

While the articulated arms 11 pass from the position of FIG. 7 to the position of FIGS. 10 and 11, the power stem 42 of the various actuators 15 gradually re-enters up to end-of-stroke into the outer liner 40.

In doing so, the landing footboard 3 raises vertically until to protrude properly along the Z axis from the hull S of the boat B, making himself available for the landing of the aircraft in accordance with the operative configuration shown in the attached FIGS. 2 and 3.

Obviously, when the aircraft leaves the platform 1, the master, through the control means, drives the translation means 4 in the opposite direction to that one just described, orienting the articulated arms 11 according to the radial direction X and causing the landing footboard 3 entry again inside the hull S of the boat B along the vertical axis Z.

Based on the foregoing, it is, therefore, understood that the platform for the landing of an aircraft of the invention achieves the purposes and reaches the advantages mentioned above.

In execution, changes could be made to the platform of the invention consisting, for example, in translation (lifting and lowering) means of construction concept different from that one highlighted in the previous description.

In addition, other solutions of the platform here exclusively claimed might exist wherein the support structure includes components different than those ones mentioned above and illustrated in the accompanying drawings, which does not affect the advantage brought by the present invention.

It has to be underlined that the platform for the landing of an aircraft, object of the invention, may not necessarily be installed only at the prow of a boat, as in the practical example previously described, but in any area of the boat itself suitable for the purpose as far as surface extensions is concerned, for example at the central deck or stern.

It is also stated precisely that the platform for the landing of an aircraft of the invention can be mounted on an access facility different from that one on which it has been based, for the sake of pure illustration, the above description; for example, indeed, in other applications, the platform of the invention can be mounted at fixed or mobile offshore posts for plants of extraction of submarine oil, docks of ports and so on.

It is, finally, clear that many other variations may be made to the platform in question, without departing from the principle of novelty intrinsic in the inventive idea expressed here, as it is clear that, in the practical implementation of the invention, materials, shapes and sizes of the illustrated details can be changed, as needed, and replaced with others technically equivalent.

Where the constructive features and techniques mentioned in the following claims are followed by reference numbers or signs, those reference signs have been introduced with the sole objective of increasing the intelligibility of the claims themselves and therefore they have no limiting effect on the interpretation of each element identified, by way of example only, by these reference signs.

1. Platform (1) for the landing of an aircraft on an access facility (B) comprising:
a support structure (2), suitable to firmly insist on a reference surface (P) of said access facility (B);
a landing footboard (3), connected above said support structure (2) and suitable to receive said aircraft,
characterized in that it includes translation means (4), interposed between said support structure (2) and said landing footboard (3), operatively connected with said landing footboard (3) in order to move it from/to a rest position, in which said landing footboard (3) re-enters at least partially with respect to said access facility (B) along a vertical axis (Z) orthogonal to a support plane (W), remaining arranged under the open sky in order to define a support and/or sun deck landing accessible to the user to/from an operating position in which said landing footboard (3) protrudes from said access facility (B) along said vertical axis (Z), becoming available for the landing of said aircraft.

2. Platform (1) as claim 1) characterized in that in said rest position, said landing footboard (3) re-enters entirely, along said vertical axis (Z), into the overall dimensions of said access facility (B) so that said support and/or sun deck landing can be safely used by the user.

3. Platform (1) as claim 1) or 2) characterized in that said support structure (2) includes a composite pedestal (5) having a substantially star-shaped profile.

4. Platform (1) as claim 3) characterized in that said composite pedestal (5) presents a plurality of perimetrical seats (7) radially facing outwardly, uniformly distributed on said composite pedestal (5) and spaced apart each other by trapezoidal gores (8), each of which comprises two oblique bars (9, 10) laterally delimiting said perimetrical seats (7).

5. Platform (1) as claim 4) characterized in that in said rest position of said landing footboard (3), said translation means (4) are substantially contained in said perimetrical seats (7) of said composite pedestal (5) along a radial direction (X), and in said operating position of said landing footboard (3), they protrude upwards in a substantially oblique direction (Y) which defines an obtuse angle (α) with said radial direction (X).

6. Platform (1) as claim 4) or 5) characterized in that said translation means (4) include:
a plurality of articulated arms (11), each coupled, on one hand, with said composite pedestal (5) through first constraint means (12) arranged at said perimetrical seats (7), and on the other hand, through second constraint means (13), with a star-shaped frame (14) which inferiorly supports said landing footboard (3) and is positioned parallelly and superiorly close to said composite pedestal (5) in said rest position of said landing footboard (3);
a plurality of linear actuators (15), cooperating with said articulated arms (11) for moving said landing footboard (3) between said rest position and said operating position and vice versa, and operatively connected with control means at user's disposal.

7. Platform (1) as claim 6) characterized in that said star-shaped frame (14) presents a series of closed profile peripheral compartments (16), uniformly distributed on said star-shaped frame (14) along radial lines (X′) and spaced apart each other by trapezoidal sectors (17), each of which equipped with oblique section bars (18, 19) laterally delimiting said peripheral compartments (16).

8. Platform (1) as claim 7) characterized in that, in said rest position of said landing footboard (3), said peripheral compartments (16) and said trapezoidal sectors (17) of said star-shaped frame (14) substantially faces respectively said perimetrical seats (7) and said trapezoidal gores (8) of said composite pedestal (5).

9. Platform (1) as any of the claims from 6) to 8) characterized in that each of the said articulated arms (11) includes:
a first protection plate (20) which contains one of said linear actuators (15) and is revolvingly connected with said composite pedestal (5) through said first constraint means (12);
a second protection plate (21) revolvingly connected with said star-shaped frame (14) through said second constraint means (13) and with said first protection plate (20) through third constraint means (22).

10. Platform (1) as claim 9) characterized in that said first constraint means (12) include:
a pair of anchor brackets (23), facing and spaced apart each other, partially contained in each of said perimetrical seats (7) and fixed one inside each of said oblique bars (9, 10) opposite each other of two of said trapezoidal gores (8) mutually adjacent of said composite pedestal (5);
a pair of strike wings (24) facing and spaced apart each other, projecting, at a first end (20a) of said first plate (20), from the bottom edge (25a, 26a) of the side walls (25, 26) of said first plate (20) and placed between said anchoring brackets (23) to which are at least partly facing;
a first shaft (27) which defines a first rotation axis (K) and is provided with end pins (28, 29) coupled with first through holes coaxial each other made in said anchoring brackets (23) and in said strike wings (24) in order to make them mutually integral.

11. Platform (1) as claim 10) characterized in that said strike wings (24) are monolithic with said side walls (25, 26) of said first plate (20) and define for said first plate (20) a substantial L-shaped profile in side view.

12. Platform (1) as claim 11) characterized in that said second constraint means (13) include:
a pair of hooking brackets (30), partially contained in each of said peripheral compartments (16) and fixed one inside each of said oblique section bars (18, 19) facing and opposite each other of said trapezoidal sectors (17) of said star-shaped frame (14);
a second shaft (31) defining a second rotation axis (J) and provided with end pins (32, 33) coupled with through openings coaxial each other made in said hooking brackets (30) and in the side walls (34, 35) of said second plate (21), at a first end (21a) of said second plate (21).

13. Platform (1) as claim 12) characterized in that said third constraint means (22) includes a third shaft (36) defining a third rotation axis (L) and provided with pins (37, 38) coupled with second through holes coaxial each other made in said side walls (25, 26) of said first plate (20) and in said side walls (34, 35) of said second plate (21), at a second end (20b) of said first plate (20) and a second end (21b) of said second plate (21).

14. Platform (1) as any of the claims from 9) to 13) characterized in that, in said rest position of said landing footboard (3), said second plate (21) is contained in said first plate (20) completely enclosing said linear actuators (15) between said first (20) and second plate (21), while in said operating position of said landing footboard (3), said second plate (21) is aligned with said first plate (20) along said substantially oblique direction (Y).

15. Platform (1) as any of the claims from 9) to 14) characterized in that each of said linear actuators (15) is provided with an outer liner (40), fixed to the bottom (41) of said first plate (20), and a power stem (42) connected with a support plate (46) contained in each of said perimetrical seats (7) and integral to the inner surface (23a) of said anchoring brackets (23).

16. Platform (1) as claim 15) characterized in that, in said rest position of said landing footboard (3), said power stem (42) protrudes axially up to end-of-stroke from said outer liner (40), so that the longitudinal axis (V) of said power stem (42) coincides with said radial direction (X), while, in said operating position of said landing footboard (3), said power stem (42) re-enters up to said end-of-stroke into said outer liner (40), so that said longitudinal axis (V) of said power stem (42) coincides with said substantially oblique direction (Y).

17. Platform as any of the claims from 6) to 16) characterized in that said translation means include an auxiliary reinforcement actuator, operatively connected with said control means, connected with the centre point of said star-shaped frame and the centre point of said composite pedestal and acting synchronously with said linear actuators along a central axis (Y′) orthogonal to the reference plane of said composite pedestal and said star-shaped frame.
